(19) United States
(12) Patent Application Publication
(10) Pub. No.: US 2020/0088693 A1
(43) Pub. Date: Mar. 19, 2020

(54) Method for Analyzing a Test Data Set from an Ultrasonic Test

(71) Applicant: Siemens Aktiengesellschaft, München (DE)

(72) Inventors: Johannes Vrana, München (DE); Hubert Mooshofer, München (DE)

(73) Assignee: Siemens Aktiengesellschaft, München (DE)

(21) Appl. No.: 16/609,457

(22) PCT Filed: Apr. 25, 2018
(86) PCT No.: PCT/EP2018/060537

§ 371 Date: Oct. 30, 2019

(30) Foreign Application Priority Data
May 2, 2017 (DE) 10 2017 207 331.4

(51) Int. Cl. G01N 29/44; G01N 29/07; G01N 29/24

(52) U.S. Cl. CPC G01N 29/449; G01N 29/07; G01N 2291/044; G01N 2291/101; G01N 29/2456

(57) ABSTRACT

Various embodiments include a method for ultrasonic testing of an object comprising: radiating ultrasound with an emitting unit of an emitter-receiver ultrasonic test head onto the object from a plurality of spatial positions of the emitter-receiver ultrasonic test head; acquiring a reflected time-dependent ultrasonic amplitude signal for each spatial position of the emitter-receiver ultrasonic test head with a receiving unit of the emitter-receiver ultrasonic test head, wherein the acquired ultrasonic amplitude signals form a test data set; and determining a SAFT amplitude for the volume element with a summation of the ultrasonic amplitude signals at the points in time which correspond to the runtimes of the ultrasound associated with the respective ultrasonic amplitude from the emitting unit to the volume element back to a receiving unit of the emitter-receiver ultrasonic test head.

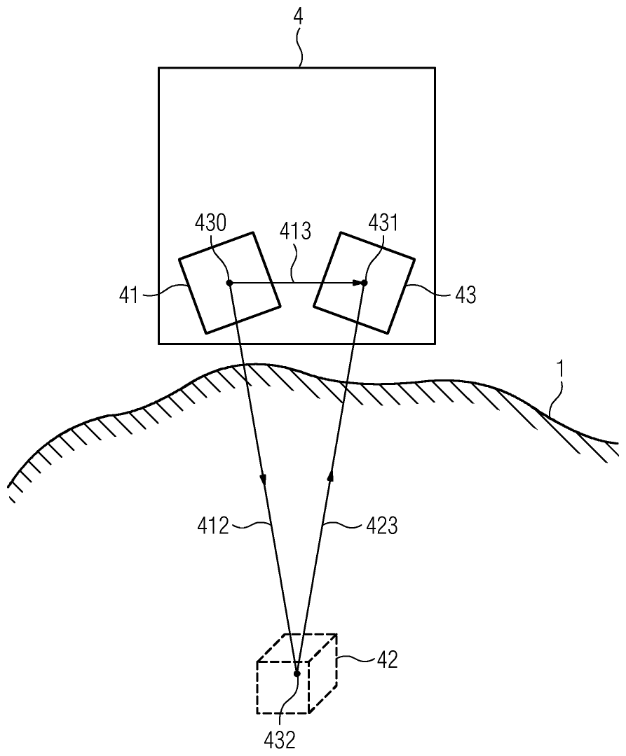

### CROSS-REFERENCE TO RELATED APPLICATIONS

This application is a U.S. National Stage Application of International Application No. PCT/EP2018/060537 filed Apr. 25, 2018, which designates the United States of America, and claims priority to DE Application No. 10 2017 207 331.4 filed May 2, 2017, the contents of which are hereby incorporated by reference in their entirety.

### TECHNICAL FIELD

The present disclosure relates to ultrasonic testing. Various embodiments may include methods for analyzing a test data set, which was ascertained by means of an ultrasonic test of an object.

### BACKGROUND

Nondestructive testing of an object by means of ultrasound (ultrasonic test) may include a SAFT method or a SAFT analysis (synthetic aperture focusing technique; abbreviated SAFT). The ultrasonic test heads used for this purpose comprise a unit which is formed simultaneously as an emitting unit and receiving unit for ultrasound. In other words, emitting position and receiving position are always identical in this case.

During an SAFT analysis (synthetic aperture focusing technique; abbreviated SAFT), typically ultrasonic amplitude signals ascertained from a plurality of spatial positions of an ultrasonic test head are offset in relation to one another for each volume element (voxel). Alternatively, a plurality of ultrasonic test heads at various spatial positions can be used for the SAFT analysis. The detection limit, for example, of defects of a component, and a position determination and size determination of such defects, may be improved by the SAFT analysis.

Furthermore, using an emitter-receiver ultrasonic test head having a separate emitting unit and receiving unit for ultrasound (abbreviated SE ultrasonic test head or SE test head) for the ultrasonic test of surface-proximal regions of the object is known. The mentioned SE test heads have a sound field characteristic different from conventional test heads, which comprise a single unit for emitting and receiving. In an SE test head, the essential regions of the sound field are arranged in the near field or in a transition region between the near field and the far field of the sound field. In particular, the sound field emitted or radiated by means of the SE test head is not rotationally-symmetrical and its phasing is different from the phasing of spherical waves. Test data which were ascertained by means of an SE test head have previously not been able to be analyzed by an SAFT analysis because of the mentioned problems.

### SUMMARY

The teachings of the present disclosure may be implemented in a SAFT analysis for test data of an SE test head. For example, some embodiments include a method for analyzing a test data set of an ultrasonic test of an object (1), which was ascertained by means of an emitter-receiver ultrasonic test head (4), and which comprises a plurality of time-dependent ultrasonic amplitude signals at least for one volume element (42) of the object (1); in which an SAFT amplitude for the volume element (42) is determined by means of a summation of the ultrasonic amplitude signals at the points in time which correspond to the runtimes of the ultrasound associated with the respective ultrasonic amplitude from an emitting unit (41) of the emitter-receiver ultrasonic test head (4) to the volume element (42) back to a receiving unit (43) of the emitter-receiver ultrasonic test head (4).

In some embodiments, the SAFT amplitude A_{SAFT} of the volume element (42) is calculated by

$${A}_{SAFT} ( {x}_{k} ) = {\sum }_{m = 1}^{N} {A}_{m} ( t = {T}_{mk} ) ,$$

wherein xₖ denotes the spatial position of the volume element (42), Aₘ(t) denotes the chronological ultrasonic amplitude signals, and Tₘₖ denotes the runtime of the ultrasound associated with the respective ultrasonic amplitude signal from the emitting unit (41) via the volume element (42) back to the receiving unit (43).

In some embodiments, the runtimes are calculated by means of a connection vector V (413) between a surface focal point (430) of the emitting unit (41) and a surface focal point (431) of the receiving unit (43).

In some embodiments, the runtimes are calculated by means of the speed of sound c via Tₘₖ=Dₘₖ/c, wherein the run distances Dₘₖ are calculated by means of the connection vector V=(V₁, V₂, 0)^{T} (413) via

$${D}_{mk} = \sqrt{{( {p}_{1} + \frac{{V}_{1}}{2} - {x}_{1} )}^{2} + {( {p}_{2} + \frac{{V}_{2}}{2} - {x}_{2} )}^{2} + {x}_{3}^{2}} + \sqrt{{( {p}_{1} - \frac{{V}_{1}}{2} - {x}_{1} )}^{2} + {( {p}_{2} - \frac{{V}_{2}}{2} - {x}_{2} )}^{2} + {x}_{3}^{2}} ,$$

and p=(p₁, P₂, 0)^{T} denotes the spatial position of the emitter-receiver ultrasonic test head (4) and xₖ=(x₁, x₂, x₃)^{T}ₖ denotes the spatial position (432) of the volume element (42).

In some embodiments, the run distances Dₘₖ are adapted to the geometric shape of a subregion of the surface of the object (1).

In some embodiments, the connection vector V (413) is ascertained by means of an at least partial survey of the sound field emitted by the emitter-receiver ultrasonic test head (4).

In some embodiments, the connection vector V (413) is ascertained by means of an at least partial simulation of the sound field emitted by the emitter-receiver ultrasonic test head (4).

As another example, some embodiments include a method for ultrasonic testing of an object (1), comprising the following steps: providing an emitter-receiver ultrasonic test head (4); radiating ultrasound by means of an emitting unit (41) of the emitter-receiver ultrasonic test head (4) onto the object (1) from a plurality of spatial positions of the emitter-receiver ultrasonic test head (4); acquiring at least one reflected time-dependent ultrasonic amplitude signal for each spatial position of the emitter-receiver ultrasonic test head (4) by means of a receiving unit of the emitter-receiver ultrasonic test head (4), wherein the acquired ultrasonic amplitude signals form a test data set; and analyzing the test data set by means of a method as claimed in any one of claims 1 to 7.

### BRIEF DESCRIPTION OF THE DRAWING

Further advantages, features, and details of the teachings herein are illustrated in light of an exemplary embodiment described hereafter and on the basis of the drawing. In this case, the single FIGURE shows a schematic section of an SE test head and an associated connection vector incorporating teachings of the present disclosure. Identical, equivalent, or identically-acting elements can be provided with the same reference signs in the FIGURE.

### DETAILED DESCRIPTION

In some embodiments, a method for analyzing a test data set of an ultrasonic test of an object, which test data set was ascertained by means of an emitter-receiver ultrasonic test head, and which comprises a plurality of time-dependent ultrasonic amplitude signals at least for one volume element of the object; an SAFT amplitude for the volume element is determined by means of a summation of the ultrasonic amplitude signals at the points in time which correspond to the runtimes of the ultrasound associated with the respective ultrasonic amplitudes from an emitting unit of the emitter-receiver ultrasonic test head to the volume element back to a receiving unit of the emitter-receiver ultrasonic test head.

The emitter-receiver ultrasonic test head can be referred to in abbreviated form as an SE test head hereafter. In other words, an SAFT analysis of the test data, which were ascertained by means of the SE test head, is enabled by the methods taught herein. This is the case because the spatial distance between the emitting unit and the receiving unit is taken into consideration according to the invention via the runtimes of the respective ultrasonic signal. In this case, the emitting unit, the volume element, and the receiving unit span a triangle, wherein the side length from the emitting unit to the volume element and the side length from the volume element to the receiving unit define the corresponding runtimes of the ultrasonic amplitude signals. In other words, in contrast to a known SAFT analysis, not only the distance, i.e., the runtime between the test head and the volume element is taken into consideration, but rather also the distance between its emitting unit and receiving unit.

In some embodiments, the detection limit of defects in the mentioned ranges is improved, and also the size evaluation, the locating, and the separation thereof from possible group displays are improved. In some embodiments, a method for the ultrasonic testing of an object comprises the following steps:
providing an emitter-receiver ultrasonic test head;
radiating ultrasound by means of an emitting unit of the emitter-receiver ultrasonic test head onto the object from a plurality of spatial positions of the emitter-receiver ultrasonic test head;
acquiring at least one reflected time-dependent ultrasonic amplitude signal for each spatial position of the emitter-receiver ultrasonic test head by means of a receiving unit of the emitter-receiver ultrasonic test head, wherein the acquired ultrasonic amplitude signals form a test data set; and
analyzing the test data set by means of a method for analyzing the test data set of the ultrasonic test of the object according to the present invention or one of its embodiments.

In some embodiments, the SAFT amplitude A_{SAFT} of the volume element is formed by

$${A}_{SAFT} ( {x}_{k} ) = {\sum }_{m = 1}^{N} {A}_{m} ( t = {T}_{mk} ) ,$$

wherein xₖ denotes the spatial position of the volume element, Aₘ(t) denotes the chronological ultrasonic amplitude signals, and Tₘₖ denotes the runtime of the ultrasound associated with the respective ultrasonic amplitude signal from the emitting unit via the volume element back to the receiving unit. Typically, the test data set for each spatial position of the SE test head (test head position) comprises at least one ultrasonic amplitude signal for this purpose. A plurality of ultrasonic amplitude signals can be provided for one test head position. The number of the ultrasonic amplitudes provided for the volume element is denoted by N in the above equation.

In some embodiments, the runtimes are formed by means of a connection vector V between a surface focal point of the emitting unit and a surface focal point of the receiving unit. The mentioned geometrical surface focal points are typically defined by a surface of the emitting unit or receiving unit, respectively, which is formed by a section parallel to an incidence direction of the SE test head. In this case, the section can extend through an axis of symmetry of the SE test head.

In some embodiments, the connection vector is formed by the two surface focal points. Accordingly, its absolute value corresponds to the spatial distance of the two surface focal points. The absolute value of the connection vector can thus be used as a measure of the spatial distance between the emitting unit and the receiving unit. In particular, this distance characterizes an SE test head, so that the connection vector is particularly advantageously suitable for determining the runtimes. In other words, the SE test head can be characterized by the connection vector. For this purpose, the connection vector is located perpendicularly on a plane which corresponds to a symmetrical division of the SE test head (with respect to the geometric arrangement of the emitting unit and the receiving unit).

The connection vector is independent in this case from a roof angle of the SE test head, i.e., an angle between the emitting unit and the receiving unit. The roof angle influences the sound field radiated by the SE test head, however. In some embodiments, the connection vector is perpendicular to a scanning direction in a two-dimensional SAFT method. This is the case because the aperture angle of the sound field is enlarged in the mentioned direction.

In some embodiments, the runtimes are calculated by means of the speed of sound c via Tₘₖ=Dₘₖ/c, wherein the run distances Dₘₖ are calculated by means of the connection vector V=(V₁, V₂, 0)^{T} via

$${D}_{mk} = \sqrt{{( {p}_{1} + \frac{{V}_{1}}{2} - {x}_{1} )}^{2} + {( {p}_{2} + \frac{{V}_{2}}{2} - {x}_{2} )}^{2} + {x}_{3}^{2}} + \sqrt{{( {p}_{1} - \frac{{V}_{1}}{2} - {x}_{1} )}^{2} + {( {p}_{2} - \frac{{V}_{2}}{2} - {x}_{2} )}^{2} + {x}_{3}^{2}} ,$$

and p=(p₁, P₂, 0)^{T} denotes the spatial position of the emitter-receiver ultrasonic test head (test head position) and xₖ=(x₁, x₂, x₃)^{T}ₖ denotes the spatial position of the volume element. The above equation of the run distances may be derived by means of the connection vector. Furthermore, the region of the object to be tested is to be approximately flat for the applicability of the above equation.

In some embodiments, the run distances Dₘₖ and/or the formula expression thereof are adapted to the geometric shape of a subregion of the surface of the object. Corresponding equations or formula expressions for the run distances may be found and specified by geometric considerations and relationships for curved surfaces.

In some embodiments, the connection vector V is ascertained by means of an at least partial survey of the sound field emitted by the emitter-receiver ultrasonic test head. In other words, the sound field radiated by the SE test head can be measured by a plurality of local measurements and thus approximately determined. The spatial position of the emitting unit and the receiving unit can then be derived therefrom. The connection vector between the emitting unit and the receiving unit can thus be inferred.

In some embodiments, the connection vector is ascertained by means of an at least partial simulation of the sound field emitted by the emitter-receiver ultrasonic test head. The determination of the connection vector by means of the partial measurement of the sound field and/or the mentioned simulation can take place in such a way that the run distances Dₘₖ are reproduced as accurately as possible, while no value is placed on the correct reproduction of the actual distance between emitting unit and receiving unit.

As shown in the FIGURE, the SE test head 4 comprises an emitting unit 41 and a receiving unit 43. The emitting unit 41 is provided for radiating ultrasound onto an object 1. The receiving unit is designed for receiving ultrasound (echoes) reflected from the object 1. After an acquisition of the reflected ultrasound by means of the receiving unit 43, it is provided in the form of time-dependent ultrasonic amplitude signals, which form a test data set of the object 1 in the plurality thereof. The emitting unit 41 and the receiving unit 43 have an angle in relation to one another, i.e., the SE test head 4 has a roof angle.

Furthermore, a geometric surface focal point 430 of the emitting unit 41 and a geometrical surface focal point 431 of the receiving unit are indicated in the FIGURE. A connection vector 413, which characterizes the SE test head 4, is defined by the two geometrical surface focal points. The absolute value of the connection vector 413 corresponds to the distance of the two surface focal points 430, 431, i.e., the spatial distance between the emitting unit 41 and the receiving unit 43.

For an SAFT analysis, the object 1 is categorized or broken down into a plurality of volume elements. Only one such volume element is illustrated in the FIGURE. A triangle is spanned by the emitting unit 41, the volume element 42, and the receiving unit 43. The runtime of the ultrasound from the emitting unit 41 to the volume element 42 corresponds to the length of a side 412 of the spanned triangle. The runtime of ultrasound reflected from the volume element 42 from the volume element 42 to the receiving unit 43 corresponds to the length of a further side 423 of the spanned triangle. A further, last side of the spanned triangle is formed by the connection vector 413.

The lengths of the sides 412, 423 can be determined by means of the connection vector 413, so that using the corresponding speed of sound, the runtime of the ultrasound from the emitting unit 41 to the volume element 42 and back to the receiving unit 43 can be ascertained. Such a runtime is ascertained for each ultrasonic amplitude signal of the test data set.

The reconstructed SAFT amplitude A_{SAFT}(xₖ) of the volume element 42 then results from a summation of the time-dependent ultrasonic amplitude signals for the above-mentioned associated runtimes.

In other words, A_{SAFT}(xₖ)=Σₘ₌₁^{N}Aₘ(t=Tₘₖ) is calculated, wherein xₖ denotes the spatial position of the volume element 42, Aₘ(t) denotes the chronological ultrasonic amplitude signals, and Tₘₖ denotes the runtime of the ultrasound associated with the respective ultrasonic amplitude signal from the emitting unit 41 via the volume element 42 back to the receiving unit 43.

In some embodiments, the SE test head can be characterized by a connection vector as defined in the present disclosure. Although the teachings herein were illustrated and described in greater detail by the exemplary embodiment, the scope of the teaching is not thus restricted by the disclosed examples or other variations can be derived therefrom by a person skilled in the art without leaving the scope of protection of the teachings herein.

What is claimed is:

1. A method for ultrasonic testing of an object, the method comprising:
radiating ultrasound with an emitting unit of an emitter-receiver ultrasonic test head onto the object from a plurality of spatial positions of the emitter-receiver ultrasonic test head;
acquiring a reflected time-dependent ultrasonic amplitude signal for each spatial position of the emitter-receiver ultrasonic test head with a receiving unit of the emitter-receiver ultrasonic test head, wherein the acquired ultrasonic amplitude signals form a test data set; and
determining a SAFT amplitude for the volume element with a summation of the ultrasonic amplitude signals at the points in time which correspond to the runtimes of the ultrasound associated with the respective ultrasonic amplitude from the emitting unit to the volume element back to a receiving unit of the emitter-receiver ultrasonic test head.

2. The method as claimed in claim 1, wherein the SAFT amplitude A_{SAFT} of the volume element is calculated by
$${A}_{SAFT} ( {x}_{k} ) = {\sum }_{m = 1}^{N} {A}_{m} ( t = {T}_{mk} ) ,$$
wherein xₖ denotes the spatial position of the volume element (42), Aₘ(t) denotes the chronological ultrasonic amplitude signals, and Tₘₖ denotes the runtime of the ultrasound associated with the respective ultrasonic amplitude signal from the emitting unit via the volume element back to the receiving unit.

3. The method as claimed in claim 2, further comprising calculating the runtimes using a connection vector V between a surface focal point of the emitting unit and a surface focal point of the receiving unit.

4. The method as claimed in claim 3, further comprising calculating the runtimes using a speed of sound c via Tₘₖ=Dₘₖ/c, wherein the run distances Dₘₖ are calculated by means of the connection vector V=(V₁, V₂, 0)^{T} (413) via
$${D}_{mk} = \sqrt{{( {p}_{1} + \frac{{V}_{1}}{2} - {x}_{1} )}^{2} + {( {p}_{2} + \frac{{V}_{2}}{2} - {x}_{2} )}^{2} + {x}_{3}^{2}} + \sqrt{{( {p}_{1} - \frac{{V}_{1}}{2} - {x}_{1} )}^{2} + {( {p}_{2} - \frac{{V}_{2}}{2} - {x}_{2} )}^{2} + {x}_{3}^{2}} ,$$
and p=(p₁, p₂, 0)^{T} denotes the spatial position of the emitter-receiver ultrasonic test head and xₖ=(x₁, x₂, x₃)^{T}ₖ denotes the spatial position of the volume element.

5. The method as claimed in claim 4, further comprising correcting the run distances Dₘₖ to account for a geometric shape of a subregion of a surface of the object.

6. The method as claimed in claim 3, further comprising determining the connection vector V using of a survey of a sound field emitted by the emitter-receiver ultrasonic test head.

7. The method as claimed in claim 3, further comprising determining the connection vector V using a simulation of the sound field emitted by the emitter-receiver ultrasonic test head.

8. (canceled)
